(19) United States
(12) Patent Application Publication
(10) Pub. No.: US 2026/0091857 A1
(43) Pub. Date: Apr. 2, 2026

(54) TOWER-INTEGRATED OFFSHORE WIND POWER FLOATING BODY AND METHOD FOR MANUFACTURING SAME

(71) Applicant: SAMWON MILLENNIA, Yongin-si, Gyeonggi-do (KR)

(72) Inventor: Ji Hyun LEE, Sejong-si (KR)

(73) Assignee: SAMWON MILLENNIA, Yongin-si, Gyeonggi-do (KR)

(21) Appl. No.: 19/111,408

(22) PCT Filed: Jul. 21, 2023
(86) PCT No.: PCT/KR2023/010587

§ 371 Date: Mar. 13, 2025

(30) Foreign Application Priority Data
Feb. 3, 2023 (KR) 10-2023-0014562

(51) Int. Cl. B63B 35/44; B63B 22/20; F03D 13/25

(52) U.S. Cl. CPC B63B 35/4406; B63B 22/20; F03D 13/256; B63B 2035/446; F05B 2240/95

(57) ABSTRACT

A tower-integrated offshore wind power floating body includes a tower formed under a power generation unit, transition pieces (TPs) spaced apart from a lower circumference of the tower at regular intervals, a seating part formed under the tower and the TP to support lower portions of the tower and the TP, a reinforcement column having the same axis as a vertical central axis of the tower and formed under the seating part, a buoyancy part formed under the reinforcement column, a ballast part formed under the buoyancy part such that the ballast part is spaced a length from the buoyancy part, a brace formed between the seating part and the buoyancy part, a brace formed between the buoyancy part and the ballast part, and main columns arranged in a vertical direction in the TP, the seating part, the buoyancy part, and the ballast part, and the main columns.

### TECHNICAL FIELD

The present invention relates to a wind power generator and a method of manufacturing the same.

### BACKGROUND ART

Wind power generators are known as a type of renewable power generation means.

A wind power generator may be classified as an onshore or offshore wind power generator depending on an installation location thereof. Types of offshore wind power generators that are usually used include a concrete caisson type, a monofile type, a jacket type, and a floating type depending on its foundation structure.

The concrete caisson type offshore wind power generator corresponds to a method of maintaining a position thereof through a weight thereof and a frictional force of a sea floor and has an advantage in that the concrete caisson type offshore wind power generator is relatively easily manufactured and installed. However, the concrete caisson type offshore wind power generator may be used at a relatively shallow water depth of 6 m to 10 m, and in poor ground, may cause eccentric slope stability problems.

The monofile type offshore wind power generator corresponds to a method of driving or drilling a large-diameter pile into the sea floor and fixing the pile and is known to have excellent economic feasibility when used in a large-scale complex. The monofile type offshore wind power generator is currently one of the most common basic methods, and may be installed at a water depth of 25 m to 30 m. As a disadvantage, a fatigue load or a corrosion problem on a member is pointed out.

The jacket type offshore wind power generator uses a jacket-type structure fixed to the sea floor through piles. The jacket type offshore wind power generator has an advantage that it may be applied in a relatively wide range of water depths of 20 m to 30 m and has excellent economic feasibility when built in a large-scale complex like the monofile type offshore wind power generator. Further, the jacket type offshore wind power generator is known to be highly reliable because relatively many successful examples have been built.

The floating type offshore wind power generator corresponds to a method of floating a floating body on the sea. In general, the floating type offshore wind power generator is intended to be applied at a water depth of 60 m to 120 m. The floating type offshore wind power generator may be applied to open sea or deep sea, which is relatively deep, due to low water depth constraints, and accordingly, is recognized as one of the important tasks of future offshore wind power generation.

Meanwhile, among floating type offshore wind power generators, a spar type, a semi-submersible type, and a tension-leg platform (TLP) type, which differ in the type of the floating body, are known.

The spar type offshore wind power generator uses a floating body in the form of a column. The spar type offshore wind power generator has an advantage of excellent motion performance because the spar type offshore wind power generator has a small water plane area and a sufficient depth below a draft line. Further, the spar type offshore wind power generator may have an advantage in terms of manufacturing due to a simple structure and shape thereof, may have a center of gravity that is lower than a center of buoyancy so that a possibility of overturning is low, and may be applied at a relatively deep water depth of 150 m or more. However, it is pointed out as a disadvantage that the spar type offshore wind power generator is difficult to move or install.

The semi-submersible type offshore wind power generator is a model using a ship-like restoration moment and corresponds to a method of attenuating vertical movement of a platform by semi-submerging a substructure having a large amount of drainage to reduce an effect of waves at sea level. The semi-submersible type offshore wind power generator may be operated at a shallow water depth as compared to the spar type offshore wind power generator and may be transferred through a tug boat or the like. However, there is a disadvantage that a high-cost ballast system is required.

The TLP type offshore wind power generator corresponds to a method of coupling the sea floor and the substructure using an elastic member. Similar to the semi-submersible type offshore wind power generator, the TLP type offshore wind power generator may be applied at a relatively low water depth and has excellent hive motion reduction performance corresponding to waves. However, the TLP type offshore wind power generator is disadvantageous in operation due to negative damping or the like as an excessive surge motion is caused compared to other floating bodies. Further, the TLP type offshore wind power generator corresponds to a mooring method in which the TLP type offshore wind power generator is connected to an undersea ground, installation of a sea floor base anchoring system is quite difficult, and when some of a plurality of mooring lines break down or are damaged, there is a risk of overturning.

### RELATED ART DOCUMENTS

Patent Document 1: Korean Patent Registration No. 10-2239547 (announced on Apr. 14, 2021)

Patent Document 2: Korean Patent Registration No. 10-1270602 (announced on Dec. 10, 2018)

Patent Document 3: Korean Patent Registration No. 10-1144423 (announced on Aug. 12, 2020)

Patent Document 4: U.S. Patent Registration No. 9499241 (registered on Nov. 22, 2016)

### DISCLOSURE

### Technical Problem

As a wind power generator becomes larger such that an output thereof is greater than 15 MW, a floating offshore wind power generator should consider both static and dynamic structural stabilities as well as fluid performance by external forces such as wind, waves, and currents, and secure economic feasibility. Thus, the present invention is designed to simultaneously satisfy economic perspectives of manufacturing, transportation, and installation as well as fluid and structural performance.

In particular, the present invention is designed to be able to be installed even at a low water depth by taking advantages of a spar type offshore wind power generator and a semi-submersible type offshore wind power generator. The spar type offshore wind power generator has high stability because a center of gravity is lower than a center of buoyancy like a roly-poly toy, but cannot be installed at a low water depth because a deep water depth of 150 m or more is required. On the other hand, the semi-submersible type offshore wind power generator is usually supported by a buoyant force and a ballast using three columns, and thus may be installed at a low water depth, but has disadvantages in that the center of gravity is higher than the center of buoyancy and high manufacturing costs are required.

The present invention is proposed to lower the center of gravity to increase stability, and at the same time, to be installed even at a low water depth like the semi-submersible type offshore wind power generator, by mixing the advantages of the spar type offshore wind power generator and the semi-submersible type offshore wind power generator. Further, the present invention is proposed so that a tower and a floating body are integrally manufactured.

### Technical Solution

The present invention is intended to solve the above problems, and relates to a tower-integrated offshore wind power floating body (100 including a tower (3) formed under a power generation unit (2), a plurality of transition pieces (TPs) (4) formed to be spaced apart from a lower circumference of the tower (3) at regular intervals, a seating part (5) formed under the tower (3) and the TP (4) to support lower portions of the tower (3) and the TP (4), a reinforcement column (7) having the same axis as a vertical central axis of the tower (3) and formed under the seating part (5), a buoyancy part (9) formed under the reinforcement column (7), a ballast part (11) formed under the buoyancy part (9) such that the ballast part (11) is spaced a certain length from the buoyancy part (9), a brace (8) formed between the seating part (5) and the buoyancy part (9), a brace (10) formed between the buoyancy part (9) and the ballast part (11), and several main columns (6) arranged in a vertical direction in the TP (4), the seating part (5), the buoyancy part (9), and the ballast part (11), and the main columns (6), wherein the main columns (6) are formed to pass through side surfaces of the seating part (5) and the buoyancy part (9) and formed to be seated under a side surface of the TP (4).

Further, the present invention relates to the tower-integrated offshore wind power floating body (100), wherein the TP (4) may be of a three-legged type.

Further, the present invention relates to the tower-integrated offshore wind power floating body (100), wherein the numbers of the reinforcement columns (7) and the main columns (6) may be three.

Further, the present invention relates to the tower-integrated offshore wind power floating body (100), wherein the tower (3), the reinforcement column (7), and the main columns (6) may have cylindrical shapes.

Further, the present invention relates to the tower-integrated offshore wind power floating body (100), wherein the braces (8, 10) may have truss shapes.

Further, the present invention relates to the tower-integrated offshore wind power floating body (100), wherein the tower-integrated offshore wind power floating body (100) may be manufactured through a design of a draft line (D) such that only three of the main columns (6) are in contact with sea level.

Further, the present invention relates to a method of manufacturing the tower-integrated offshore wind power floating body (100), wherein the tower (3) is manufactured by being integrally welded on land.

Further, the present invention relates to the method of manufacturing the tower-integrated offshore wind power floating body (100), wherein the tower (3) manufactured by being integrally welded and all or some other components are welded and coupled.

### Advantageous Effects

The present invention has the above configuration, and thus a wind power generator according to the present invention can minimize an installation process on sea so that benefits such as ease of work, time, and cost can be expected.

Further, the wind power generator according to the present invention can have the advantages of a semi-submersible support structure and a spar-type support structure together. That is, the wind power generator according to the present invention can secure excellent mooring performance in an installation state while having excellent mobility.

Further, the wind power generator according to the present invention can be proposed to be applied to various installation environments related to a water depth, to actively cope with a buoyant force of a structure or the like depending on an operating environment, and to receive less wave power by minimizing a water plane area, and minimize a hive motion and a surge motion in motion of a floating body with six degrees of freedom.

### DESCRIPTION OF DRAWINGS

FIG. 1 is a schematic view of a tower-integrated offshore wind power generator according to an embodiment of the present invention.

FIG. 2 is a schematic view of a tower-integrated offshore wind power floating body according to the embodiment of the present invention.

FIG. 3 is a front view of the tower-integrated offshore wind power floating body according to the embodiment of the present invention.

### MODES OF THE INVENTION

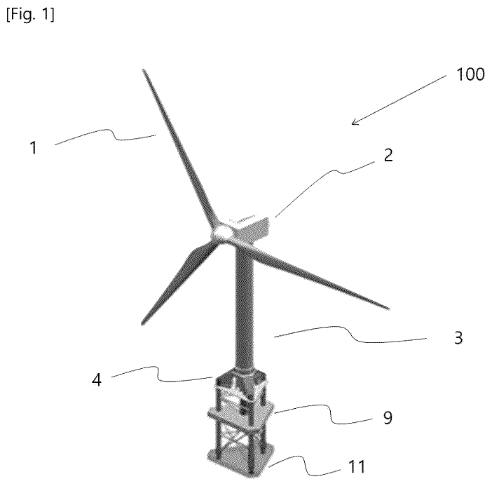

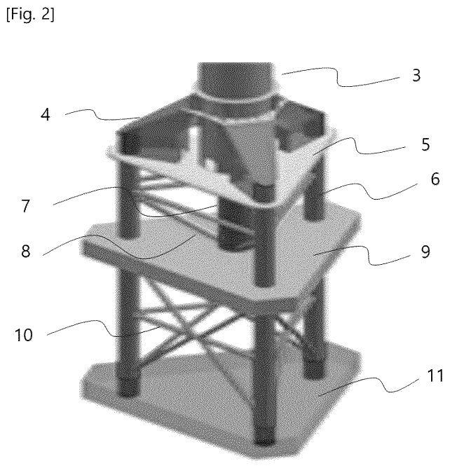

The present invention may be variously changed and have various embodiments, and hereinafter, an exemplary structure of the present invention will be illustrated with reference to FIGS. 1 and 2, and the present invention will be described in detail based thereon. However, this is not intended to limit the present invention only to the illustrated form, and the spirit and technical scope of the present invention include even ordinary changes, equivalents, or substitutes in the illustrated form.

Terms used in the present application are used only to describe the specific embodiments and are not intended to limit the present invention. Singular expressions include plural expressions unless clearly otherwise indicated in the context. It should be understood in the present application that terms such as “include” or “have” are intended to indicate that there are features, numbers, steps, operations, components, parts, or combinations thereof that are described in the specification and do not exclude in advance the possibility of the presence or addition of one or more other features, numbers, steps, operations, components, parts, or combinations thereof.

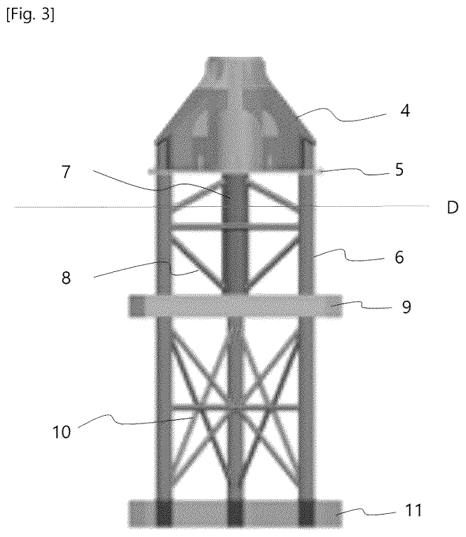

FIGS. 1 and 2 are schematic views of a tower-integrated offshore wind power generator and floating body according to an embodiment of the present invention. FIG. 3 is a front view of the tower-integrated offshore wind power floating body according to the embodiment of the present invention.

Referring to FIG. 1, a tower-integrated offshore wind power floating body 100 includes a blade 1, a power generation unit 2, a tower 3, a transition piece (TP) 4, a seating part 5, a main column 6, a reinforcement column 7, a brace 8, a buoyancy part 9, a brace 10, and a ballast part 11.

The blade 1 serves to generate mechanical energy while being rotated by wind.

The power generation unit 2 includes a gearbox and a generator and converts the mechanical energy generated by the blade 1 into electrical energy. The corresponding electric energy is transferred to a substation.

Since the tower 3 supports the power generation unit 2 and secures static and dynamic structural strength, the tower-integrated offshore wind power floating body 100 may have sufficient resistance from an external force.

The TP 4 serves to distribute a load such as a large bending moment and a self-weight due to wind and waves applied to a lower portion of the tower 3 and reduce displacement of the tower 3. Further, the TP 4 includes various machines such as a winch and a ballast pump that operate an anchor chain for maintaining a position of the floating body and a controller therein. The anchor chain for maintaining the position of the floating body is formed from the TP 4 to an undersea ground.

The seating part 5 serves to support lower portions of the tower 3 and the TP 4.

The main column 6 is defined as a structure having the purpose of separating the buoyancy part 9 and the ballast part 11 for lowering a center of gravity, connecting the separated components, and fixing positions thereof and thus has a smaller diameter than that of a semi-submersible type offshore wind power generator and a spar type offshore wind power generator. Therefore, the main column 6 is affected less by wave forces, and thus motion performance can be improved, and manufacturing costs can be reduced. Further, a cavity is formed inside a pipe to ensure a buoyant force. A main column of a semi-submersible type floating body is widely spaced apart from the tower 3 and has a large diameter for the purpose of the buoyant force and the ballast. One main column of a spar type floating body is formed and is long.

The reinforcement column 7 serves to support vertical loads of the blade 1, the power generation unit 2, and the tower 3.

The brace 8 serves to distribute and support loads of the structures such as the main column 6 and the reinforcement column 7.

The buoyancy part 9 is a structure that provides a buoyant force for floating the entire weight of the tower-integrated offshore wind power floating body 100. In order to control a heave motion of the floating body, a heave plate is usually mounted on the floating body. However, in the present invention, the buoyancy part 9 may replace a function thereof without installing a separate heave plate.

The brace 10 serves to distribute and support loads of the structures such as the buoyancy part 9 and the ballast part 11.

The ballast part 11 is manufactured of a concrete or iron structure and serves to lower the center of gravity of the floating body by its own weight. In order to control the heave motion of the floating body, the heave plate is usually mounted on the floating body. However, in the present invention, the ballast part 11 may replace a function thereof without installing a separate heave plate.

Referring to FIGS. 1 and 2, a structure in which the blade 1 and the power generation unit 2 are coupled may be formed. The tower 3 may be formed under the power generation unit 2 and support the blade 1 and the power generation unit 2. It is preferable in terms of offshore stability that the tower 3 have a cylindrical shape.

The TP 4 may be formed as a plurality of TPs 4 that are spaced apart from a lower circumference of the tower 3 at regular intervals. A three-legged TP 4 may be structurally preferable.

The seating part 5 may be formed below the tower 3 and the TP 4 to support the lower portions of the tower 3 and the TP 4.

The reinforcement column 7 having the same axis as a vertical central axis of the tower 3 may be formed under the seating part 5. It may be preferable in terms of offshore stability that the reinforcement column 7 have a cylindrical shape.

The buoyancy part 9 may be formed under the reinforcement column 7. The ballast part 11 may be formed under the buoyancy part 9 such that the ballast part 11 is spaced a certain length from the buoyancy part 9. The brace 8 may be formed between the seating part 5 and the buoyancy part 9. The brace 8 may have a truss shape. The brace 10 may be formed between the buoyancy part 9 and the ballast part 11. The brace 10 may have a truss shape.

A plurality of main columns 6 may be arranged in a vertical direction in the TP 4, the seating part 5, the buoyancy part 9, and the ballast part 11. The main column 6 is formed to pass through side surfaces of the seating part 5 and the buoyancy part 9, formed to be seated under a side surface of the TP 4, and formed to be seated on the side surface of the seating part 5. When the TP 4 is of a three-legged type, it may be preferable that three main columns 6 be formed. It may be preferable that the main column 6 have a cylindrical shape.

FIG. 3 illustrates a draft line D of the tower-integrated offshore wind power floating body 100 in contact with sea level when the tower-integrated offshore wind power floating body 100 is installed on the sea. In design and manufacturing processes, the center of gravity, the amount of drainage, and the like of each of the components may be optimized so that the tower-integrated offshore wind power floating body 100 may have the corresponding draft line D on the sea.

A technical feature of the tower-integrated offshore wind power floating body 100 according to the present invention will be described below.

First) a manufacturing method in which the tower 3 and other components are integrally welded and coupled and are transported on the sea is provided.

The tower 3 is integrally welded and coupled to the tower-integrated offshore wind power floating body 100 and integrally welds and couples all or some other components are integrally welded and coupled to the tower 3, thereby reducing installation costs by reducing maritime work, reducing transportation costs when transported integrally, securing rigidity greater than that of bolt structures through the welding and coupling, and being advantageous for maintenance. A tower generally has a structure in which several divided parts are assembled with each other with bolts. However, the tower of the present wind power generator has an entirely welded structure without bolt assembly, the bolts are removed, and thus a risk of the tower overturning due to bolt damage can be removed, and installation costs can be reduced. Further, there is no bolt fastening part in maintenance and regular inspection, and thus inspection costs can be reduced.

Second) a structure in which a three-legged TP 4 is mounted to support the power generation unit 2 is provided.

Due to the three-legged form, a wind load may be distributed, and a less wave load may be received.

Third) the brace 8 formed between the seating part 5 and the buoyancy part 9 and between the buoyancy part 9 and the ballast part 11 is a truss.

By adopting the truss form, manufacturing costs of the tower-integrated offshore wind power floating body 100 can be reduced and loads of the structures such as the main column 6, the reinforcement column 7, and the ballast part 11 can be distributed and supported.

Fourth) A machine control room is disposed in a watertight structure sealed space inside the TP 4.

As machinery, electricity, and control devices required for operating offshore wind power generators such as winches and pumps are installed in advance and transported on land, maritime work can be reduced, and thus maritime installation costs can be reduced.

Fifth) A structure in which a free water surface is formed in the cylindrical main column 6 and a minimum wave force is received is provided.

When it is determined with the draft line D of FIG. 3, which is a part in which the tower-integrated offshore wind power floating body 100 is in contact with the sea level, only three cylindrical main columns 6 are in contact with the sea level to receive a minimum wave load.

### DESCRIPTION OF REFERENCE NUMERALS

100: Tower-integrated offshore wind power floating body
1: Blade
2: Power generation unit
3: Tower
4: Transition piece (TP)
5: Seating part
6: Main column
7: Reinforcement column
8: Brace
9: Buoyancy part
10: Brace
11: Ballast part
D: Draft line

1. A tower-integrated offshore wind power floating body (100) comprising:
a tower (3) formed under a power generation unit (2);
a plurality of transition pieces (TPs) (4) formed to be spaced apart from a lower circumference of the tower (3) at regular intervals;
a seating part (5) formed under the tower (3) and the TP (4) to support lower portions of the tower (3) and the TP (4);
a reinforcement column (7) having the same axis as a vertical central axis of the tower (3) and formed under the seating part (5);
a buoyancy part (9) formed under the reinforcement column (7);
a ballast part (11) formed under the buoyancy part (9) such that the ballast part (11) is spaced a certain length from the buoyancy part (9);
a brace (8) formed between the seating part (5) and the buoyancy part (9);
a brace (10) formed between the buoyancy part (9) and the ballast part (11); and
several main columns (6) arranged in a vertical direction in the TP (4), the seating part (5), the buoyancy part (9), and the ballast part (11), and the main columns (6), wherein the main columns (6) are formed to pass through side surfaces of the seating part (5) and the buoyancy part (9) and formed to be seated under a side surface of the TP (4).

2. The tower-integrated offshore wind power floating body (100) of claim 1, wherein the TP (4) is of a three-legged type.

3. The tower-integrated offshore wind power floating body (100) of claim 2, wherein the numbers of the reinforcement columns (7) and the main columns (6) are three.

4. The tower-integrated offshore wind power floating body (100) of claim 1, wherein the tower (3), the reinforcement column (7), and the main columns (6) have cylindrical shapes.

5. The tower-integrated offshore wind power floating body (100) of claim 1, wherein the braces (8, 10) have truss shapes.

6. The tower-integrated offshore wind power floating body (100) of claim 1, wherein the tower-integrated offshore wind power floating body (100) is manufactured through a design of a draft line (D) such that only three of the main columns (6) are in contact with sea level.

7. A method of manufacturing the tower-integrated offshore wind power floating body (100) of claim 1, wherein the tower (3) is manufactured by being integrally welded on land.

8. The method of claim 7, wherein the tower (3) manufactured by being integrally welded and all or some other components are welded and coupled.
